(19) United States
(12) Patent Application Publication
(10) Pub. No.: US 2016/0078038 A1
(43) Pub. Date: Mar. 17, 2016

(54) EXTRACTION OF SNIPPET DESCRIPTIONS USING CLASSIFICATION TAXONOMIES

(71) Applicants: Sameep Navin Solanki, San Jose, CA (US); Jagadish Nallapaneni, San Jose, CA (US); Tracy Holloway King, Mountain View, CA (US); Naren Chittar, San Jose, CA (US)

(72) Inventors: Sameep Navin Solanki, San Jose, CA (US); Jagadish Nallapaneni, San Jose, CA (US); Tracy Holloway King, Mountain View, CA (US); Naren Chittar, San Jose, CA (US)

(21) Appl. No.: 14/852,391

(22) Filed: Sep. 11, 2015

Related U.S. Application Data
(60) Provisional application No. 62/049,278, filed on Sep. 11, 2014.

(51) Int. Cl. G06F 17/30

(52) U.S. Cl. CPC G06F 17/3053; G06F 17/30867; G06F 17/30528; G06F 17/30011; G06F 17/30554

(57) ABSTRACT

Systems and methods are presented for generating snippets from document data within the document and category taxonomies. In some embodiments, the system may receive a document comprising a set of paragraphs and sentences, identify text in the document relating to a set of categories, and score the paragraphs based on a relation between the paragraph and the set of categories to produce a section score. The system determines one or more sentences for inclusion in a snippet based in part on the section score. The system generates a snippet from the sentences determined for inclusion and associates the snippet with the document.

### TECHNICAL FIELD

The subject matter disclosed herein generally relates to generating descriptions for query results. Specifically, the present disclosure addresses systems and methods to facilitate extracting and presenting a snippet from a document presented within a set of search results.

### BACKGROUND

Internet searches often use keywords in order to determine a result having some combination of the keywords contained in a document, website, database, etc. In addition to a location of the identified results, search engines, websites, operating system based searches, and the like may include snippets. In some instances, the snippet may be a summary, while in others, the snippet may be a listing of sentences, partial sentences, or phrases containing keywords or variants of those keywords entered in the search.

### BRIEF DESCRIPTION OF THE DRAWINGS

Some embodiments are illustrated by way of example and not limitation in the figures of the accompanying drawings.

FIG. 1 is a network diagram illustrating a network environment suitable for extracting snippets, according to some example embodiments.

FIG. 2 is a block diagram illustrating components of a snippet server suitable for extracting snippets, according to some example embodiments.

FIG. 3 is a flowchart illustrating operations of a device in performing a method of extracting and generating snippets, according to some example embodiments.

FIG. 4 is a flowchart illustrating operations of the device of FIG. 3 in performing a method of extracting and generating snippets, according to some example embodiments.

FIG. 5 is a flowchart illustrating operations of the device of FIG. 3 in performing a method of extracting and generating snippets, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

Example methods and systems are directed to extracting or generating summaries or snippets of information from search results, listing results, or other results to display to a user. In some embodiments, methods and systems are presented using classification taxonomies as input for extracting snippets from a search result or listing. The snippet provides information determined to be relevant, extracted from a source, in a shortened set of text. The snippet may provide description while maintaining diversity of content to prevent repetition within the snippet. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Aspects of the present disclosure are presented for extracting snippets of information, such as from a document or website, and displaying the information to a user. In some example embodiments, snippets are extracted using information from the document and information from metadata related to the document. Snippets may be automatically generated to display document excerpts from documents, websites, or the like identified in the search results. This manner of generating a snippet is called a contextual or dynamic abstract due to the contents of the snippets differing based on submitted search terms. In these methods, the snippet may be generated at least in part on a query type or a location of the query terms in the document. Snippets may also be generated using a pre-generated abstract describing the topic or content of the document. Some snippets are generated by a combination of contextually generated document text and brief excerpts or descriptions of the document as a whole. For example, a snippet can be generated from a combination of content of the document or web site; website or document coding structure; a query typed in a search field, historical information about the user; a classification taxonomy into which a document, web site, or listing is placed; title words; hierarchical relationships between words used in the document or words used in the metadata relating to the document; non-hierarchical word relationships, such as synonym relationships and antonym relationships; word usage conventions within a classification taxonomy; and word frequency determinations.

As discussed in the present disclosure, a document from which snippets are extracted can be a text document, a web site, a web page, a product listing, or any other document from which a text snippet may be extracted. In some embodiments, the snippet provides a summary of the document indicative of the contents of the document. In some embodiments, the snippet provides differentiating information, such as a snippet for a product listing, to enable a user to distinguish between similar but distinct product listings.

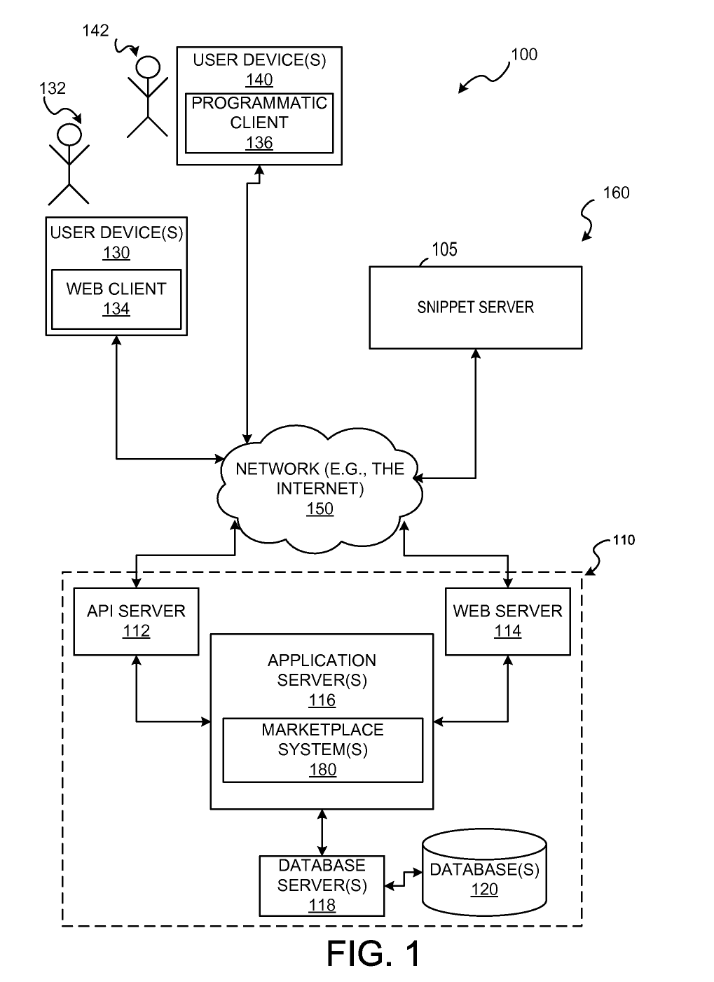

FIG. 1 is a network diagram illustrating a network environment 100 suitable for extracting snippets from electronic documents using classification taxonomies, according to some example embodiments. The network environment 100 includes a snippet server 105, a server machine 110, a database 120, and devices 130 and 140, all communicatively coupled to each other via a network 150.

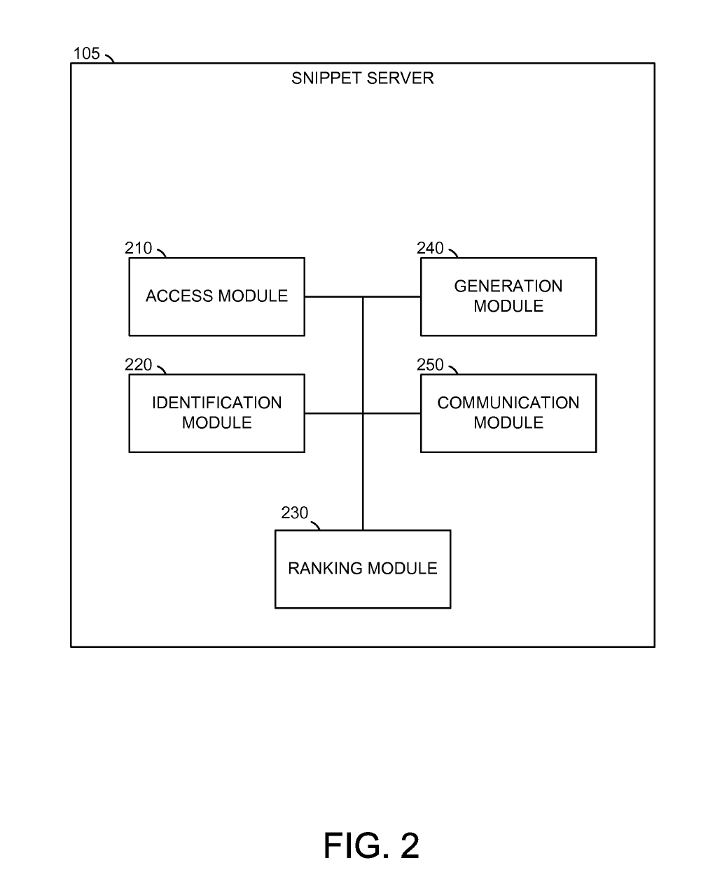

The snippet server 105, explained in more detail with reference to FIG. 2, can form all or part of a network-based publication system 160 configured to extract or generate snippets from documents, websites, product listings, or other information resources available for searching via the network 150. In some embodiments, the snippet server 105 is implemented as a portion of the server machine 110, discussed below. For example, the snippet server 105 can be implemented as a module comprising hardware or hardware-software implemented modules configured to extract and provide snippets to the server machine 110 and the device 130 and 140. In these embodiments, the snippet server 105 may directly or indirectly communicate with one or more of the API server 112, the web server 114, the application server 116, and the database 120. In some embodiments, the snippet server 105 may be implemented using hardware components of the application server 116.

The server machine 110 is shown as including an API server 112, a web server 114, an application server 116, a database server 118, and the database 120. In some embodiments, the server machine 110 forms all or part of a network-based system 170 (e.g., a cloud-based server system configured to provide one or more services to the devices 130 and 140). The snippet server 105, the server machine 110, and the devices 130 and 140 may each be implemented in a computer system, in whole or in part, as described below with respect to FIG. 11.

The API server 112 provides a programmatic interface by which the device 130 and 140 can access the server machine 110.

The application server 116 may be implemented as a single application server 116 or a plurality of application servers. The application server 116, as shown, hosts one or more marketplace system 180, which comprises one or more modules or applications and which may be embodied as hardware or hardware-software implemented modules with software or firmware configuring hardware to perform operations specified for the modules or applications. The application server 116 is, in turn, shown to be coupled to the database server 118 that facilitates access to one or more information storage repositories or database(s), such as the database 120.

The marketplace system 180 provides a number of market place functions and services to users that interface with the network-based publication system 160. For example, the marketplace system(s) 180 can provide information for products for sale or at auction facilitated by the marketplace system(s) 180 and displayable in devices 130 and 140. In some embodiments, the marketplace 180 provides listings for products indicative of the information for products. The listings for products can be stored in the database 120 and may be searchable by through the network-based publication system 160. The listings may include information indicative of a product, a condition of the product, terms of sale for the product, shipping information, a description of the product, a quantity, metadata associated the product, metadata associated with coding for the listing, and information indicative of product organization, such as titles, categories, category taxonomies, and product interrelations. The marketplace system(s) 180 can also facilitate the purchase of products in the online marketplace that can later be delivered to buyers via shipping or any conventional method.

While the marketplace system 180 is shown in FIG. 1 to form a part of the network-based system 170, it will be appreciated that, in some embodiments, the marketplace system 180 may form part of a payment service that is separate and distinct from the network-based system 170. Further, while the client-server-based network environment 100 shown in FIG. 1 employs a user-server architecture, the present disclosure is not limited to such architecture, and may equally well find application in a distributed architecture system (e.g., peer-to-peer), for example. The various marketplace system(s) 180 may also be implemented as standalone systems, which do not necessarily have networking capabilities.

While the marketplace system(s) 180 is shown in FIG. 1 to form part of the networked-based system 170, it will be appreciated that, in alternative embodiments, the marketplace system(s) 180 may form part of a payment service that is a part of the networked-based system 170.

The database server 118 is coupled to the database 120 and provides access to the database 120 for the device 130 and 140 and other aspects of the server machine 110. The database 120 can be a storage device that stores information related to products; documents; web sites; metadata relating to products, documents, or websites; and the like.

Also shown in FIG. 1 are users 132 and 142. One or both of the users 132 and 142 can be a human user (e.g., a human being), a machine user (e.g., a set of hardware configured by software to interact with the device 130), or any suitable combination thereof (e.g., a human assisted by a machine or a machine supervised by a human). The user 132 is not part of the network environment 100, but is associated with the device 130 and is a user of the device 130. For example, the device 130 can be a desktop computer, a vehicle computer, a tablet computer, a navigational device, a portable media device, a smartphone, or a wearable device (e.g., a smart watch or smart glasses) belonging to the user 132. Likewise, the user 142 is not part of the network environment 100, but is associated with the device 140. As an example, the device 140 can be a desktop computer, a vehicle computer, a tablet computer, a navigational device, a portable media device, a smartphone, or a wearable device (e.g., a smart watch or smart glasses) belonging to the user 142.

The device 130 and 140 contains a web client 134 which may access the various marketplace system(s) 180 and, in some cases, the snippet server 105, via the web interface supported by the web server 114. Similarly, a programmatic client 136 is configured to access the various services and functions provided by the marketplace system(s) 180 and, in some cases, the snippet server 105, via the programmatic interface provided by the API server 112. The programmatic client 136 may, for example, perform batch-mode communications between the programmatic client 136 and the networked-based publication system 160 and the snippet server 105.

Any of the machines, databases, or devices shown in FIG. 1 may be implemented as hardware (e.g., at least one processor) modified (e.g., configured or programmed) by software or firmware to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 150 may be any network that enables communication between or among machines, databases, and devices (e.g., the server machine 110 and the device 130). Accordingly, the network 150 can be a wired network, a wireless network (e.g., a mobile or cellular network), or any suitable combination thereof. The network 150 can include one or more portions that constitute a private network, a public network (e.g., the Internet), or any suitable combination thereof. Accordingly, the network 150 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 150 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

FIG. 2 is a block diagram illustrating components of the snippet server 105, according to some example embodiments. The snippet server 105 is shown as including an access module 210, an identification module 220, a ranking module 230, a generation module 240, and a communication module 250, all configured to communicate with each other (e.g., via a bus, shared memory, or a switch). Any one or more of the modules described herein can be implemented using hardware (e.g., one or more processors of a machine) or a combination of hardware and software. For example, any module described herein can be implemented by configuring a processor (e.g., among one or more processors of a machine) to perform the operations described herein for that module. Moreover, any two or more of these modules can be combined into a single module, and the functions described herein for a single module can be subdivided among multiple modules. Furthermore, according to various example embodiments, modules described herein as being implemented within a single machine, database, or device may be distributed across multiple machines, databases, or devices.

Although the snippet server 105 is shown as a separate component, it will be understood that the snippet server 105 may be included in the server machine 110. For example, the snippet server 105 can be a module implemented using hardware or a combination of hardware and software. In embodiments where the snippet server 105 is a module, the snippet server 105, or modules contained within the snippet server 105, configures a processor to perform operations described herein for the snippet server 105. Additionally, the snippet server 105 can be combined with one or more other module of the server machine 110.

In various embodiments, the access module 210 accesses a product listing from a client device (e.g., the client device 130 or client device 140). The access module 210 may access the product listing stored on the database 120. In some instances, where the snippet server 105 is a separate system from the server machine 110, as shown in FIG. 1, the access module 210 accesses the product listing via the network 150, transmitting a request to one or more of the web server 114. For example, the access module 210 may generate a request for a product listing from the database 120. The web server 114 may cooperate with the database 120 to provide the product listing.

In some embodiments, the identification module 220 automatically identifies text in a set of text sections of a product listing. The text sections relate to the set of categories associated with the product which is the subject of the product listing. The identification module 220 may identify text sections, such as sentences, sets of words, category structures, or the like. The text sections identified may be limited to those text structures containing a number of characters exceeding a predetermined limit. For example, the identification module 220 may identify sentences having a number of characters exceeding a character limit or words exceeding a word frequency limit. The identification module 220 may identify text from the product listing by parsing the content and metadata of the product listing. For example, in some instances where the product listing is presented as an HTML document, the identification module 220 parses HTML of the product listing, including associated HTML documents. The identification module 220 parses the content of the product listing including the description of the product listing as well as metadata relating to the product listing such as categories, image metadata, and other documents or metadata included in the product listing or associated therewith.

In various instances, the ranking module 230 scores the set of text sections identified by the identification module 220. For example, in some embodiments where each of the set of text sections is a paragraph, the ranking module 230 scores a paragraph using word frequency scores for each sentence of the paragraph. The word frequency score may be generated by identifying occurrences of words and synonyms within a sentence which are related to words appearing in a title or category designation of the product listing. The ranking module 230 may exclude sentences or text sections including certain sentences based on a sentence including identified exclusionary information. For example, the ranking module 230, in some embodiments, excludes sentences which are exact matches to a title of the product listing, include an HTML link, and includes certain common additions unrelated to a product's description (e.g., shipping information, payment information, feedback requests, and seller information).

The ranking module 230 may automatically score the set of text sections based upon receiving the identified set of text sections from the identification module 220, without intervening user interaction. The ranking module 230 score the set of text sections using a relation between the identified text and the set of categories to generate a section score. In some instances the ranking module 230 ranks the set of text sections using the section score for each text section, producing a section rank for each text section within the set of text sections. In some instances, the ranking module 230 generates section ranks as a comparative rank among the text sections of the set of text sections.

The generation module 240 determines one or more portions of the set of text sections for inclusion in a snippet. For example, where the text sections are identified paragraphs, the generation module 240 determines sentences from one or more paragraphs to include in the snippet based in part on the section score corresponding to the section in which the sentence appears. In some instances, the generation module 240 includes sentences based in part on a section rank. The generation module 240 may determine sentences for inclusion by comparing one or more of the section scores, the section ranks, and the sentence score. In some instances, the generation module 240 automatically determines sentences or the one or more portions of the set of text sections for inclusion in the snippet after receiving one or more of the scoring or ranking information from the ranking module 230, without further user interaction. Receipt of the scoring or ranking information may trigger the determination of sentences and the order of sentences for inclusion in the snippet, without user intervention or action.

In some instances, the generation module 240 may modify the determination of the one or more portions of the set of text sections for inclusion in the snippet based on receiving a query identifying one or more product listings. For example, the generation module 240 may exclude or include one or more portions of the snippet or one or more sentences based on determining a relation between terms included in the query and terms identified within the one or more portions of the snippet. In these instances, the generation module 240 may retrieve a generated snippet, in response to receiving the query and information relating to parsing of the query by one or more of the modules described herein. The generation module 240 may then modify the snippet based on one or more of the query and the parsing or scoring of the terms included in the query.

In generating the snippet, after determining which sentences or portions of a text section are suitable for inclusion, the generation module 240 may initially create the snippet using a sentence or text portion having a section score, sentence score, or section rank determined to be highest among the identified text sections. The generation module 240 may then add additional sentences or text portions to the snippet until a predetermined character limit is reached.

The communication module 250 enables communication between a device (e.g., the client device 130 or 140), the snippet server 105, and the server machine 110. In some instances the communications module 250 enables communication among the access module 210, the identification module 220, the ranking module 230, and the generation module 240. The communication module 250 may be a hardware implemented module or a hardware-software implemented module. For example, the communications module 250 may include communications mechanisms such as an antenna, a transmitter, one or more bus, and other suitable communications mechanisms configured to enable communication or configurable to enable communication among the modules or one or more devices or systems described herein.

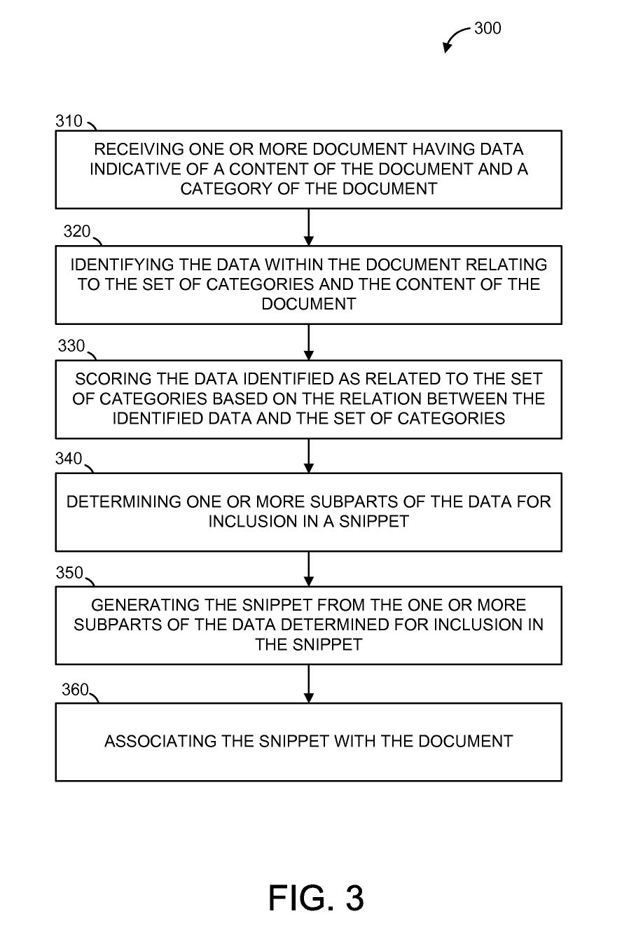

FIG. 3 is a flowchart illustrating operations of the snippet server 105 in performing a method 300 of generating a snippet for a document, in accordance with some example embodiments of the present disclosure. Operations in the method may be performed by the snippet server 105, using modules described above with respect to FIG. 2. As shown in FIG. 3, the method 300 includes operations 310, 320, 330, 340, 350, and 360. Although the operations of method 300 may be performed on the network-based publication system 160, the server machine 110, the snippet server 105, or performed on a combination thereof, for the sake of clarity, the method 300 will be described with reference to the snippet server 105. Other servers and modules are possible.

In operation 310, the snippet server 105 receives one or more documents having data indicative of a content of the document and a category of the document. The data indicative of the content of the document includes the content of the document (e.g., the description of a product, a title, shipping information, and the like in a product listing). In some instances, the data indicative of the content of the document also includes metadata associated with the content. The category can be one or more of a set of categories in a category taxonomy which identifies the document, for example as part of a category in a hierarchy. Additionally, the category can include a title of a category or sub-category, metadata relating to a category or sub-category, and a category path extending between a broad category in the set of categories to the category (e.g., a narrower category) of the document. For example, where the category is part of a category hierarchy, the category path includes information about an initial general category and each subcategory stemming from the initial general category within the hierarchy between the initial general category and the category of the document. By way of further example, a product listing for gold and diamond wedding ring may include a category path of jewelry, rings, wedding rings, jeweled band, and jeweled gold band. In some embodiments the document can contain metadata such as categories, document coding, and the like. For example, when the document is a web page of a web site, the document may be coded in HTML and include scripts, javascript, style information, headers, tags, carriage returns, and other associated elements not directly indicative of the content of the document.

In some embodiments, operation 310 may be performed by the access module 210 or a combination of the access module 210 and the communication module 250. In some embodiments, the access module 210 may access documents for the server to receive one or more document without a user providing input directly to the snippet server 105. For example, as part of an automated process, the access module 210 may access the database 120 by communicating with the server machine 110 across the network 150. The access module 210 accesses the one or more documents (e.g., web pages, network accessible documents, product listings, or social networking profiles) stored on the database 120. The access module 210 may be configured to access the database 120 at regular intervals, after an event (e.g., a backup event, a restoration event, or an indication of one or more documents being added to or modified). In some instances, the server machine 110 may generate a notification for the snippet server 105 based on one or more event, such as a plurality of new documents being uploaded to the database 120 to trigger the access module 210 of the snippet server 105 to access the one or more documents stored on the database 120. For example, in some embodiments where the server machine 110 generates a notification for the access module 210, the access module 210 may access one or more documents uploaded to the database 120 since the last operation of the access module 210, as indicated in the notification.

In operation 320, the snippet server 105 identifies the data within the document relating to the set of categories and the content of the document. Where the content of the document is text, the snippet server 105 may identify specific words within the text relating to the set of categories. For example, the snippet server 105 matches a term within the text to a term in a title of the document, a variant of the term in the title, a synonym of a term from the title, a term from the category or the set of categories, a variant of the term from the category or the set of categories, a synonym of a term from the category or the set of categories, or the like, to determine a relationship between the words of the text and the category or set of categories. In some embodiments, the snippet server 105 additionally matches terms within the text to terms which are contextually related to the title or the category, but which are not direct synonyms. In some embodiments where the document includes text data, the snippet server 105 precludes from scoring and consideration one or more text section or paragraph where the text section or paragraph does not contain a term relating to the title, category, or set of categories, as described above, as will be described in more detail below.

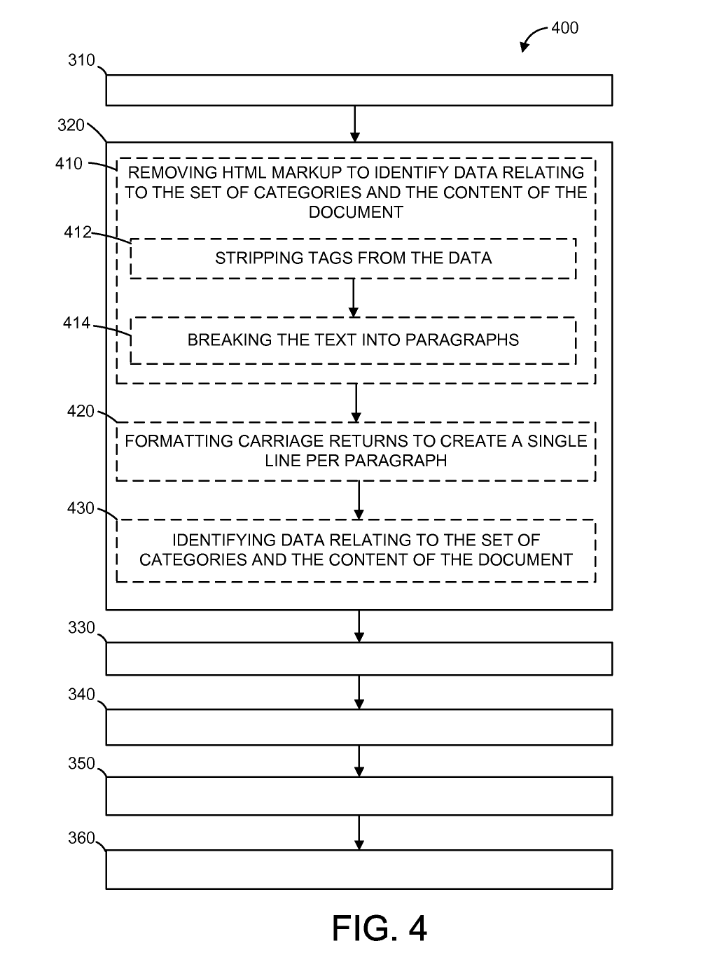

In some embodiments, operation 320 may be performed by the identification module 220 of the snippet server 105 or a combination of the identification module 220 and the communication module 250. For example, the identification module 220 may identify data within the document by approximate string matching, the Aho-Corasick algorithm, the Commentz-Walter algorithm, the Boyer-Moore string search algorithm, the Levenshtein automation, or any other suitable method for identifying a match or similarity between two sets of text. In various embodiments, the operation 320 may include sub operations, as shown in FIG. 4.

In operation 330, the ranking module 230 scores the data identified from the content of the document as related to the set of categories based on the relation between the identified data and the set of categories to produce a data score. In some embodiments, where the content of the document is text data, the ranking module 230 scores a set of text sections based on a relation of one or more terms within the text section and the set of categories.

In some embodiments, the snippet server 105 may score the data, producing the data score, based on discrete subsets of the data. A score for a section of text (e.g., a data score) may be referred to herein as a section score. For example, where the data is a set of paragraphs, each of the set of paragraphs may be scored and provided a section score based on a scoring of individual sentences within each paragraph. The individual sentences may each be scored, in this embodiment, and the snippet server 105 may score a paragraph based, at least in part, on the sentence scores for sentences within that paragraph. In some embodiments, scoring may depend on a value of a term, a value of a sentence, a position value based on a position of a sentence within a paragraph, or combinations thereof.

For example, the ranking module 230 may generate section scores by generating a score for each sentence within a text section (e.g., a paragraph). The ranking module 230 may generate sentence scores by determining a normalized frequency of words within each sentence of the text section. For example, the ranking module 230 determines a frequency for each word within the sentence by identifying a number of times the word appears in all documents (e.g., all documents within the database 120) to determine an overall frequency. The ranking module 230 may divide the overall frequency by a category frequency to generate a token score. The category frequency may be a number of times the word appears in documents within an identified category. In these embodiments, words having a high frequency in both the overall frequency and the category frequency may receive a lower score, indicating lesser importance as a distinguishing feature of the document. Where a word occurs with a lower frequency, the word may be provided a higher score, indicating importance as a distinguishing feature.

In order to normalize the sentence scores, the ranking module 230 may determine the total number of tokens (e.g., words having a token score) within the sentence. The ranking module 230 may then combine (e.g., add) the token scores for each token (e.g., word) within the sentence to generate a non-normalized token score. The ranking module 230 may then divide the non-normalized token score by the total number of tokens within the sentence to produce a normalized sentence score.

After the ranking module 230 determines the sentence score for each sentence within a text section (e.g., a paragraph), the ranking module 230 may generate the section score for the text section. The section score may be generated as a function of each of the sentence scores within the text section. For example, the section score may be a normalized average of the sentence scores for sentences included within the section. Here, each sentence score may be added together and divided by the number of sentences within the section.

In various embodiments, the section score may be a weighted section score. For example, the ranking module 230 determines a position of the paragraph within the document and generates a weighted section score. A position weight may be determined by determining whether the position of the section exceeds a predetermined threshold. For example, if the section is within the first forty-eight paragraphs of the document, the weight may be 1−(paragraph number*0.02). Where the section occurs after the forty-eighth paragraph, the weight may be 0.04.

In some embodiments, in addition to scoring the data, the snippet server 105 ranks the data. For example, where the content of the document is text data having a set of text sections, the snippet server 105 ranks the set of text sections based on the section score of each text section in the set of text sections to produce a section rank for each text section. In some embodiments, the section rank for each text section is generated as a comparative rank between each of the text sections of the set of text sections. The comparative rank may be determined by comparing the section scores or the weighted section scores, placing the sections in order based on their respective section scores or weighted section scores from highest to lowest.

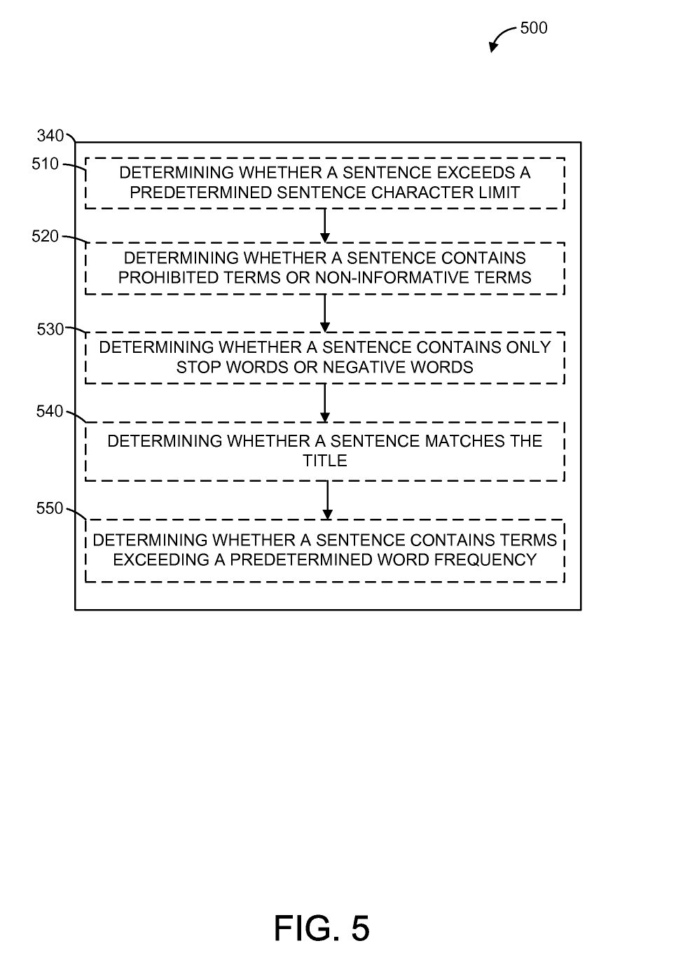

In operation 340, the snippet server 105 determines one or more subparts of the data for inclusion in a snippet. In some embodiments, the snippet server 105 determines the one or more subparts for inclusion based on the data score, the data rank, or a combination thereof. For example, as described above in embodiments with text sections and sentences selected from text sections, one or more sentences may be determined for inclusion based on the section score or the section rank. In some embodiments, the operation 340 is performed by the generation module 240 of the snippet server 105. The generation module 240 can determine the subparts of the data for inclusion in the snippet and the order in which to include those subparts within the snippet. For example, the generation module 240 may order the subparts in the order in which they appear in the document or in another contextually based order.

Where the content of the document is text data with text sections formed of sentences, the snippet server 105 may determine sentences to include after breaking or otherwise partitioning the text sections into their respective sentences. In these embodiments, the snippet server 105 may begin by determining the top scoring (e.g., a paragraph having a section score above the section scores of the other paragraphs in the document) or top ranked paragraph. In some embodiments, the operation 340 may include one or more sub-operations, described in FIG. 5.

The generation module 240 may determine the one or more subparts for inclusion based on a score for the subpart (e.g., sentence score). For example, in some embodiments, the generation module 240 identifies the sentence with the highest sentence score for inclusion in the snippet. In various embodiments, the generation module 240 determines the paragraph with the highest section score and identifies one or more sentences within that paragraph for inclusion in the snippet. For example, the generation module 240 may determine the paragraph with the highest section score and determine one or more sentences, having the highest sentence score for that paragraph for inclusion in the snippet. The generation module may additionally include one or more sentence based on exclusion or inclusion factors and operations, such as those described below with respect to FIG. 5.

In operation 350, the snippet server 105 automatically generates the snippet from the one or more subparts of the data identified or determined for inclusion in the snippet. For example, the snippet server 105 may generate the snippets without user intervention once the one or more subparts of the data have been identified. In these embodiments, identifying the one or more subparts triggers the generation of the snippets. In instances where the identification of the one or more subparts triggers the generation of the snippets, the generation may occur immediately following the identification. In some instances, the generation may be scheduled, for example in a queue, such that after one or more unrelated operations have been processed, the snippet server 105 generates the snippet when a queue position of the operation 350 is to be processed. Where the content of the document is text data, for example, the one or more subparts may be sentences and the snippet can be generated by extracting the one or more sentences, or a copy of the one or more sentences, from the document. As discussed above and as will be discussed below in more detail with respect to FIG. 5, the generation module 240 may select the one or more sentences to extract based on operation 340 or sub-operations of the operation 340. In some embodiments, the operation 350 is performed by the generation module 240 of the snippet server 105. For example, the generation module 240 may determine the subparts of the data to be included in the snippet and the order of inclusion and generate the snippet appending successive subparts to an initial subpart.

In some embodiments, the snippet has a predetermined character limit. In these embodiments, the snippet server 105 can initially select the first sentence for inclusion in the snippet and then generate the snippet by appending one or more additional sentences, such as one or more selected sentences, to the first sentence until the predetermined character limit has been reached. For example, the predetermine character limit may be 400 characters, in some instances. In some instances, the predetermined character limit may be between 170 and 240 characters, based on a set of factors described below. In some embodiments, the snippet server 105 limits the display of a last sentence used to generate the snippet where the sentence extends past the predetermined character limit. In some embodiments, the snippet server 105 may exclude a last sentence used to generate the snippet, where the sentence extends past the predetermined character limit, to generate the snippet while maintaining the predetermined character limit and only presenting complete sentences.

In some embodiments, predetermined character limits may be determined based on a set of factors. For example, the predetermined character limit may be determined, at least in part, based on the type of machine or module implementing the method 300. For example, the predetermined character limit may be based on display of the snippet for a mobile device, where the predetermined character limit may be determined to be the amount of characters able to be displayed on a screen of a mobile device (e.g., smartphone, tablet, etc.) given a font in use, a font size in use, a screen size, and an application type. For example, borders, pictures, or other elements within an application which may occupy space, over which a snippet may not be displayed, may reduce the available character limit for the predetermined character limit.

Further, in some embodiments, the snippet may be compatible with search engine optimization processes to provide the snippet with a document link within search results of a third party search engine. For example, where the method 300 is implemented in conjunction with the marketplace system 180, a search engine may search through item listings within the marketplace system 180 having titles and descriptions. The item listings may further be organized by a category taxonomy. When a user searches, through a search engine, the item listings and receives a result set, some of the titles of the item listings may not appear relevant to the search performed by the search engine. The snippet may provide perceived relevance to an item listing in the result set where the title of the item listing would have provided little or no perceived relevance.

In some embodiments, the snippet may be included in a graphical user interface of a social media website or application, where the document, item listing, or other content, for which a snippet is generated, is posted, pinned, or otherwise shared between users of a social media site. For example, a first user wants to share an item listing with a second user. The item listing may include a snippet with descriptive information extracted from the content of the item listing. When the first user posts, pins, or otherwise shares the item listing with the second user, the snippet may appear as a default caption of the item listing, a picture of the item, or a link to the item listing. Further, where an item listing or other document (e.g., an image) is shared over social media, when a user hovers a mouse pointer over the item listing or other document, the snippet may be inserted into a selectable element displayed above or proximate to the item listing or other document on the screen. In some embodiments, where the snippet is provided as a selectable element, an overlay, a pop-up or the like, a user may select the snippet to receive more information. For example, selecting the snippet may cause the browser to be directed to another website, open a website in a pop-up window, or open a website in a tab within the browser. The website may be a website associated with the item listing or other document described by the snippet.

In some embodiments, the snippet, generated by the snippet server 105, may contain a user friendly or user readable version of the category or category taxonomy associated with the document or product listing for which the snippet was generated.

In operation 360, the snippet server 105 associates the snippet with the document. For example, the snippet server 105 can store the document and the snippet in a relational database, store the snippet within or appended to the document, or provide a link in either the snippet or the document to the other. The association of the document and the snippet causes the snippet to be retrieved and displayed, within a graphical user interface, to the user 132 or 142, for example on the device 130 or 140, when the user 132 or 142 causes the networked-based publication system 160, the server machine 110, the snippet server 105, or another system to search for the document by generating and transmitting a query to one or more of the above-referenced systems. The snippet is displayed to the user 132 or 142 in addition to a link directing the user 132 or 142 to the document location or otherwise enabling retrieval of the document. In some embodiments, the operation 360 is performed by the generation module 240 or a combination of the generation module 240 and the communication module 250 of the snippet server 105.

For example, in some embodiments, in the operation 310, the snippet server 105 may receive a product listing having a set of text sections associated with the product and a set of categories associated with the product. The text sections may comprise a set of text sections subdivisions. By way of example, the product listing may be presented on a web site and shown as divided into paragraphs, indicative of the text sections, and sentences in the paragraphs, indicative of the text section subdivisions. In these embodiments, in the operation 320, the snippet server 105 identifies text in the set of text sections relating to the set of categories. In the operation 330, the snippet server 105 may score the set of text sections based on the relation between the identified text and the set of categories to produce a section score. In the operation 340, the snippet server 105 determines one or more sentences for inclusion in a snippet based in part on the section score of the text section to which the sentence corresponds. In these embodiments, in the operation 350, the snippet server 105 generates the snippet from the one or more sentences determined for inclusion in the snippet and, in the operation 360, associates the snippet with the product listing. The snippet server 105 then serves the snippet based on the server machine 110 or the network based publication system 160 receiving a query from a user device (e.g., user device 130 or user device 140).

In some embodiments, the snippets generated by one or more of the methods 300, 400, and 500 may be initially generated as a static snippet. The static snippet may be stored with or in association to the document to which the static snippet pertains. When the snippet server 105 receives a query from a user device, or an indication of a query from the server machine 110, the snippet server 105 may serve the snippet to the server machine 110 for inclusion along with an identification of the document within a set of results to the search query. In some instances, the static snippet may be modified by based on one or more of the query, the user device transmitting the query, network traffic, or other suitable factors. For example, where the user device includes a display device (e.g., a touchscreen) with a visible area below a predetermined measurement, the query may be accompanied by a measurement indication of the display device size (e.g., a measurement of visible area or an indication of falling below or exceeding the predetermined measurement). The measurement indication may be passed to the snippet server 105. The snippet server 105 may perform a lookup operation to determine an appropriate snippet length based on the measurement indication. The snippet server 105 modifies the static snippet to meet or fall below a character limit associated with the snippet length. For example, the snippet server 150 may truncate the static snippet based on the sentence scores of the sentences included in the static snippet (e.g., removing sentences having the lowest score). In some instances, where the measurement indication is associated with a character limit exceeding the static snippet, the snippet server 105 may transmit the entire static snippet, or may increase the information included in the static snippet to include additional sentences based on one or more of the individual sentence scores or the section scores associated with the section including the sentence.

FIG. 4 is a flowchart illustrating operations of the snippet server 105 in performing a method 400 implementing sub-operations of the operation 320, in accordance with some example embodiments of the present disclosure. Operations in the method 400 may be performed by the snippet server 105, using modules described above with respect to FIG. 2. Although the operations of method 400 may be performed on the network-based publication system 160, the server machine 110, the snippet server 105, or performed on a combination thereof, for the sake of clarity, the method 400 will be described with reference to the snippet server 105. Other servers and modules are possible.

In various embodiments, where the document is a web page coded in HTML and the content of the document is text, the operation 320 may be divided into sub-operations. For example, in operation 410, the identification module 220 of the snippet server 105 removes the HTML markup. In identifying data relating to the set of categories, the identification module 220 may ignore anything in script, javascript, noscript, or tags and data which are style related. In operation 412, a sub-operation of operation 410, the identification module 220 strips tags from the data. In operation 414, a sub-operation of the operation 410, the identification module 220 breaks the text into paragraphs, after removing or ignoring portions of the HTML code. In some embodiments where the content of the document is text data with text sections formed of sentences, the snippet server 105 may additionally partition the text sections into sentences corresponding to the text section.

In operation 420 the identification module 220 formats (e.g., cleans or organizes) carriage returns. In some instances, the product of operation 420 may result in each paragraph being a line ending in a carriage return. The identification module 220 may generate a temporary file containing the reformatted text for processing in the operations 330-360, described above.

In operation 430, the identification module 220 identifies data within the document relating to the set of categories and the content of the document. In identifying the data within the document, the identification module 220 may employ an HTML processor, text parsing processes, document content, and word lists. The text parsing processes may include natural language tool kit sentence breakers, natural language tool kit tokenizers, language tokenizers, word breakers, word lists, and other appropriate processes. The natural language toolkit and other text parsing processes may be implemented as one or more modules. In some embodiments, a natural language toolkit module includes standard natural language processing instantiations or customized, domain specific variants, for the documents being processed.

The document content may comprise document content as originally coded for a website (e.g., an original html coded version of the document), a text version of a path from a root to a leaf of a category taxonomy, synonyms for words comprising the text version of the category taxonomy path, a document title, synonyms for the document title, and the like. Word lists may include lists, databases, or other collections of words which, when encountered by snippet server 105, may cause the snippet server to include or exclude sentences. For example, word lists may contain words weighted as negatives (e.g., suggesting exclusion of a sentence containing the word) or words weighted as positives (e.g., suggesting inclusion of a sentence containing the word). The snippet server 105 may determine varying weights for the words by connotation, context, meaning, relatedness, frequency, and the like.

FIG. 5 is a flowchart illustrating operations of the snippet server 105 in performing a method 500 implementing sub-operations of the operation 340, in accordance with some example embodiments of the present disclosure. Operations in the method 500 may be performed by the snippet server 105, using modules described above with respect to FIG. 2. Although the operations of method 500 may be performed on the network-based publication system 160, the server machine 110, the snippet server 105, or performed on a combination thereof, for the sake of clarity, the method 500 will be described with reference to the snippet server 105. Other servers and modules are possible.

In operation 510, the generation module 240 determines whether one or more sentences exceed a predetermined sentence character limit and excludes sentences exceeding the character limit. For example, the predetermined character limit may be 400 characters and the sentence may contain a number of characters totaling 405. The snippet server 105 may then exclude sentences with greater than 400 characters from inclusion in the snippet.

In operation 520, the generation module 240 determines if one or more of the sentences contain prohibited terms or non-informative terms. For example, the snippet server 105 may contain a list of prohibited terms which are indicative of sentences which do not contain item information. In these embodiments, the snippet server 105 may compare individual terms of a sentence to the prohibited terms list. Upon determining a sentence includes a prohibited term, the snippet server 105 may exclude the sentence from inclusion in the snippet.

For example, where the snippet server 105 extracts snippets from product listings on an auction or marketplace system, the list of prohibited terms may include contiguous, buyer, buyers, feedback, ship, shipping, ships, shipped, contact, email, thank, thanks, shipment, shipments, click, please, return, satisfaction, welcome, confidence, description, insured, postage, customs, additional, payment, insurance, days, store, tax, taxes, question, questions, refund, refunds, returns, or the like. When the snippet server 105 encounters sentences containing one of the above listed words, or similar words indicative of actions relating to the product listing, shipping, pleasantries, or the like, the snippet server 105 may discard the sentence as not containing product information.

In operation 530, the generation module 240 determines if one or more of the sentences contain only stop words or negative words. The snippet server 105 may exclude the sentence from inclusion in the snippet. The snippet server 105 may determine if the sentence contains a negative word and no words from the title. Upon determining a sentence includes a negative word or fails to include a word from the title or category, the snippet server 105 may exclude the sentence from inclusion in the snippet.

For example, in some embodiments such as where the snippet server 105 is used in conjunction with product listings, the negative or stop words may include a, able, about, across, after, all, almost, also, am, among, an, and, any, are, as, at, be, because, been, but, by, can, cannot, could, dear, did, do, does, either, else, ever, every, for, from, get, got, had, has, have, he, her, hers, him, his, how, however, I, if, in, into, is, it, its, just, least, let, like, likely, may, me, might, most, must, my, neither, no, nor, not, of, off, often, on, only, or, other, our, own, rather, said, say, says, she, should, since, so, some, than, that, the, their, them, then, there, these, they, this, tis, to, too, twas, us, wants, was, we, were, what, when, where, which, while, who, whom, why, will, with, would, yet, you, your, or the like. In embodiments where the above-recited words signify stop words or negative words, the snippet server 105 may identify one or more of these words in a sentence and determine whether the sentence contains any words from the title, from the category of the product listing, from the category path or hierarchy of the product listing, or synonyms of words from the title, the category, or the category hierarchy. Where the sentence contains words relating to the title or category in addition to one or more of the stop words, the sentence may be scored and, in some instances, included in the snippet. Where the sentence contains no words relating to the title or category, the sentence may be excluded from the snippet.

In operation 540, the generation module 240 determines if one or more of the sentences match the title. For example, a sentence may contain terms which are an exact match to the title, or may contain terms that are merely synonyms for the words used in the title. For example, the snippet server 105 may use a predetermined threshold of words within a title to determine if a sentence matches the title. In either example, the sentence may be determined to contain no terms which are not contained in the title of the document. Upon determining there are no additional terms in a sentence, the snippet server 105 may exclude the sentence from inclusion in the snippet.

In operation 550, the generation module 240 determines if a sentence contains terms which exceed a predetermined word frequency and exclude the sentence from inclusion in the snippet. In some embodiments, the generation module 240 determines one or more terms as exceeding the predetermined word frequency by comparing the predetermined word frequency to the frequency of the terms determined by the ranking module 230.

According to various example embodiments, one or more of the methodologies described herein may facilitate extracting or generating summaries or snippets of information from documents and category taxonomies. Moreover, one or more of the methodologies described herein may facilitate generating snippets of information for search results from product listings, category taxonomies, and document metadata, providing pertinent details from a product description to a user. The snippet may be generated from the product description, using the language of the product description, but extracting salient or differentiating details separating the product from another product. Hence, one or more of the methodologies described herein may facilitate generating snippets for product listings from classification taxonomies, as well as generating snippets for search engine results of documents based on internal or external classification taxonomies as well as the content of the document.

When these effects are considered in aggregate, one or more of the methodologies described herein may obviate a need for certain efforts or resources that otherwise would be involved in extracting snippets of information from documents and category taxonomies. Efforts expended by a user, in extracting snippets of information from documents and category taxonomies or searching through document descriptions and summaries to determine documents relevant to submitted search criteria, may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

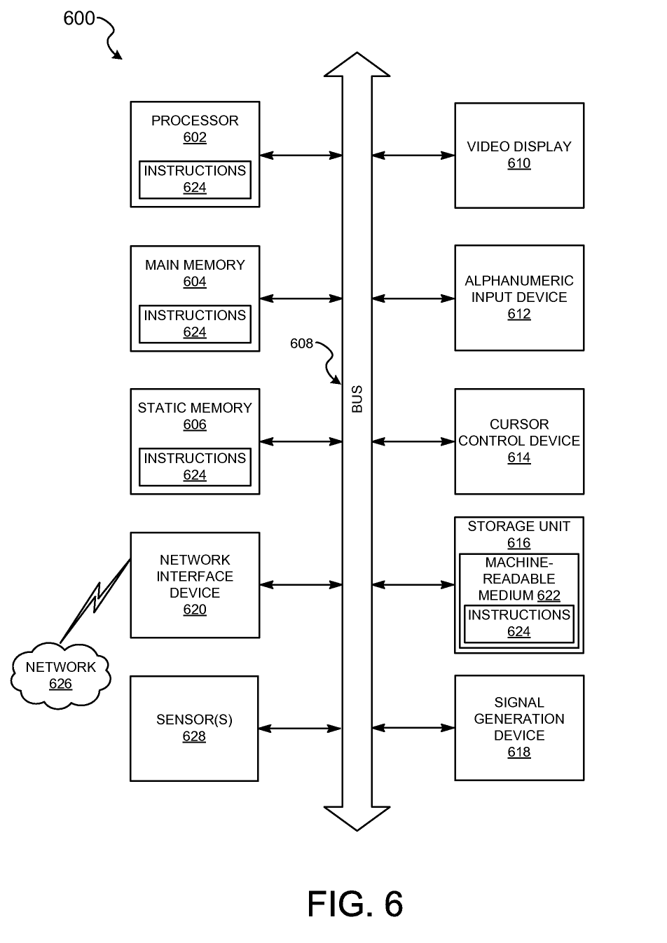

FIG. 6 is a block diagram illustrating components of a machine 600, according to some example embodiments, able to read instructions 624 (e.g., processor executable instructions) from a machine-readable medium 622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer system (e.g., a computer) within which the instructions 624 (e.g., software, a program, an application, an applet, an app, or other executable code) for causing the machine 600 to perform any one or more of the methodologies discussed herein may be executed, in whole or in part.

In alternative embodiments, the machine 600 operates as a standalone device or may be communicatively coupled (e.g., networked) to other machines. In a networked deployment, the machine 600 may operate in the capacity of a server machine or a client machine in a server-client network environment, or as a peer machine in a distributed (e.g., peer-to-peer) network environment. The machine 600 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include any collection of machines that individually or jointly execute the instructions 624 to perform all or part of any one or more of the methodologies discussed herein.

The machine 600 includes at least one processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, an audio generation device 618 (e.g., a sound card, an amplifier, a speaker, a headphone jack, or any suitable combination thereof), and a network interface device 620.

The storage unit 616 includes the machine-readable medium 622 (e.g., a tangible and non-transitory machine-readable storage medium) on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-readable media (e.g., tangible and non-transitory machine-readable media). The instructions 624 may be transmitted or received over the network 190 via the network interface device 620. For example, the network interface device 620 may communicate the instructions 624 using any one or more transfer protocols (e.g., hypertext transfer protocol (HTTP)).

In some example embodiments, the machine 600 may be a portable computing device, such as a smart phone or tablet computer, and have one or more additional input components 630 (e.g., sensors or gauges). Examples of such input components 630 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 624 for execution by the machine 600, such that the instructions 624, when executed by one or more processors of the machine 600 (e.g., processor 602), cause the machine 600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

What is claimed is:

1. A method comprising:
receiving a product listing from a client device, the product listing having a set of text sections associated with the product and a set of categories associated with the product, the text sections comprising a set of sentences;
based on receiving the product listing, automatically generating a snippet by
identifying, by a snippet server, text in the set of text sections relating to the set of categories;
based on identifying the text relating to the set of categories, automatically scoring, by the snippet server, the set of text sections based on the relation between the identified text and the set of categories to produce a section score;
based on the scoring of the set of text sections, automatically determining, by the snippet server, one or more sentences for inclusion in a snippet based in part on the section score of the text section to which the sentence corresponds; and
generating the snippet from the one or more sentences determined for inclusion in the snippet; and
associating the snippet with the product listing within a database of a network-based publication system for presentation in a graphical user interface.

2. The method of claim 1, further comprising:
ranking the set of text sections based on the section score of each text section in the set of text sections produce a section rank for each text section.

3. The method of claim 2, wherein the section ranks are generated as a comparative rank between each of the text sections of the set of text sections.

4. The method of claim 2, wherein determining one or more sentences for inclusion further comprises:
determining one or more sentences for inclusion in the snippet based in part on the section rank.

5. The method of claim 1, further comprising:
partitioning each of the text sections into the set of sentences corresponding to the text section.

6. The method of claim 1, wherein determining one or more sentences for inclusion further comprises:
identifying sentences with a number of characters exceeding a predetermined character limit; and
identifying sentences containing words exceeding a predetermined word frequency.

7. The method of claim 1, wherein the product listing further comprises a title and wherein determining one or more sentences for inclusion further comprises:
identifying sentences containing a predetermined threshold of words contained in the title.

8. The method of claim 1, wherein generating the snippet further comprises:
creating the snippet with a first sentence of the one or more sentences; and
adding additional sentences of the one or more sentences until a predetermined character limit is reached.

9. A system, comprising:
an access module configured to receive a product listing from a client device, the product listing having a set of text sections associated with the product and a set of categories associated with the product, the text sections comprising a set of sentences;
an identification module, implemented by at least one processor of a snippet server, configured to identify text in the set of text sections relating to the set of categories;
a ranking module, implemented by at least one processor of the snippet server, configured to automatically score the set of text sections based on the relation between the identified text and the set of categories to produce a section score; and
a generation module, implemented by at least one processor of the snippet server, configured to:
automatically determine one or more sentences for inclusion in a snippet based in part on the section score of the text section to which the sentence corresponds;
generate a snippet from the one or more sentences determined for inclusion in the snippet; and
associate the snippet with the product listing within a database of a network-based publication system.

10. The system of claim 9, wherein the ranking module ranks the set of text sections based on the section score of each text section in the set of text sections produce a section rank for each text section.

11. The system of claim 10, wherein the section ranks are generated as a comparative rank between each of the text sections of the set of text sections.

12. The system of claim 10, wherein the generation module determines one or more sentences for inclusion in the snippet based in part on the section rank.

13. The system of claim 9, wherein the generation module is configured to partition each of the text sections into the set of sentences corresponding to the text section.

14. The system of claim 9, wherein the generation module is configured to identify sentences with a number of characters exceeding a predetermined character limit and identify sentences containing words exceeding a predetermined word frequency.

15. The system of claim 9, wherein the generation module generates the snippet by creating the snippet with a first sentence of the one or more sentences and adding additional sentences of the one or more sentences until a predetermined character limit is reached.

16. A non-transitory machine-readable storage medium comprising processor executable instructions that, when executed by a processor of a machine, cause the machine to perform operations comprising:
receiving a product listing from a client device, the product listing having a set of text sections associated with the product and a set of categories associated with the product, the text sections comprising a set of sentences;
based on receiving the product listing, automatically generating a snippet by
identifying, by a snippet server, text in the set of text sections relating to the set of categories;
based on identifying the text relating to the set of categories, automatically scoring, by the snippet server, the set of text sections based on the relation between the identified text and the set of categories to produce a section score;
based on the scoring of the set of text sections, automatically determining, by the snippet server, one or more sentences for inclusion in a snippet based in part on the section score of the text section to which the sentence corresponds; and
generating the snippet from the one or more sentences determined for inclusion in the snippet; and
associating the snippet with the product listing within a database of a network-based publication system.

17. The non-transitory machine-readable storage medium of claim 16, wherein the operations further comprise:
ranking the set of text sections based on the section score of each text section in the set of text sections produce a section rank for each text section.

18. The non-transitory machine-readable storage medium of claim 17, wherein the operations further comprise:
determining one or more sentences for inclusion in the snippet based in part on the section rank.

19. The non-transitory machine-readable storage medium of claim 16, wherein the operations further comprise:
identifying sentences with a number of characters exceeding a predetermined character limit; and
identifying sentences containing words exceeding a predetermined word frequency.

20. The non-transitory machine-readable storage medium of claim 16, wherein the operations further comprise:
creating the snippet with a first sentence of the one or more sentences; and
adding additional sentences of the one or more sentences until a predetermined character limit is reached.
